(19) United States
(12) Patent Application Publication
(10) Pub. No.: US 2022/0388845 A1
(43) Pub. Date: Dec. 8, 2022

(54) BORON NITRIDE POWDER AND PRODUCTION METHOD THEREFOR, BORON CARBONITRIDE POWDER, COMPOSITE MATERIAL, AND HEAT DISSIPATING MEMBER

(71) Applicant: Denka Company Limited, Chuo-ku, Tokyo (JP)

(72) Inventors: Go TAKEDA, Chuo-ku, Tokyo (JP); Haruka TAKEOKA, Chuo-ku, Tokyo (JP); Takaaki TANAKA, Chuo-ku, Tokyo (JP)

(73) Assignee: Denka Company Limited, Chuo-ku, Tokyo (JP)

(21) Appl. No.: 17/770,475

(22) PCT Filed: Oct. 21, 2020
(86) PCT No.: PCT/JP2020/039581

§ 371 Date: Apr. 20, 2022

(30) Foreign Application Priority Data
Oct. 23, 2019 (JP) 2019-192712

(51) Int. Cl. C01B 21/064; C08K 3/38; C09K 5/14

(52) U.S. Cl. CPC C01B 21/0648; C08K 3/38; C09K 5/14; C01P 2004/50; C01P 2006/14; C01P 2006/16; C01P 2004/61; C01P 2006/11; C01P 2006/32; C08K 2201/001; C08K 2201/005; C08K 2003/385

(57) ABSTRACT

One aspect of the present invention provides a boron nitride powder that contains aggregated particles formed through aggregation of primary particles of boron nitride. The cumulative pore volume of the boron nitride powder within a fine pore radius of 0.02-1.2 μm as measured by a mercury porosimeter is 0.65 mL/g or less.

### TECHNICAL FIELD

The present disclosure relates to a boron nitride powder and a production method therefor, a boron carbonitride powder, a composite material, and a heat dissipating member.

### BACKGROUND ART

Boron nitride has lubricating properties, high heat conductive properties, insulating properties, and the like, and has been widely used for a solid lubricant, a heat conductive filler, an insulating filler, and the like. Recently, the boron nitride as described above is required to be excellent in heat conductive properties, in accordance with high performance of an electronic device, and the like.

In general, heat characteristics of boron nitride in the shape of a scale include anisotropy. That is, it is known that a heat conductivity in a thickness direction (c-axis direction) is extremely lower than heat conductive properties in an in-plane direction (a-b in-plane direction) perpendicular to the thickness direction. For example, a heat conductivity in an a-axis direction is 400 W/(m·K) whereas the heat conductivity in the c-axis direction is 2 W/(m·K). Accordingly, for example, heat characteristics of a composite material in which a resin is filled with a boron nitride powder are greatly affected by an oriented state of boron nitride particles in the composite material. For example, when preparing a composite material molded into the shape of a sheet by pressing, in many cases, the boron nitride particles are oriented in a direction perpendicular to a press direction, and heat conductive properties in the press direction decrease.

In order to avoid such a phenomenon, in Patent Literature 1, it is described that boron nitride fine particles are in the shape of a sphere having an average circularity of 0.80 or more. In addition, in Patent Literature 2, as a boron nitride powder that is filled in a resin composition of an insulating layer and a thermal interface material of a printed-wiring board and exhibits a high heat conductivity by suppressing the anisotropy of a heat conductivity and by reducing contact thermal resistance, a boron nitride powder containing boron nitride particles to which primary particles of hexagonal boron nitride are bonded, which is an aggregated body of the boron nitride particles, is described in which an average sphericity is 0.70 or more, an average particle diameter is 20 to 100 μm, a voidage is 50 to 80%, an average fine pore diameter is 0.10 to 2.0 μm, a maximum fine pore diameter is 10 μm or less, and a calcium content rate is 500 to 5000 ppm.

### CITATION LIST

### Patent Literature

Patent Literature 1: International Publication WO 2015/122379

Patent Literature 2: International Publication WO 2014/136959

### SUMMARY OF INVENTION

### Technical Problem

An object of the present disclosure is to provide a boron nitride powder capable of producing a composite material that is excellent in filling properties of boron nitride and is capable of exhibiting excellent heat conductive properties, and a production method for the boron nitride powder. Another object of the present disclosure is to provide a boron carbonitride powder useful for producing the boron nitride powder described above. Another object of the present disclosure is to provide a composite material that is excellent in filling properties of boron nitride and is capable of exhibiting excellent heat conductive properties. Another object of the present disclosure is to provide a heat dissipating member excellent in heat dissipating properties.

### Solution to Problem

One aspect of the present disclosure provides a boron nitride powder containing aggregated particles configured by aggregation of primary particles of boron nitride, in which a cumulative pore volume at a fine pore radius of 0.02 to 1.2 μm that is measured by a mercury porosimeter is 0.65 mL/g or less.

In the boron nitride powder described above, since the cumulative pore volume corresponding to fine pores having a specific fine pore radius that is measured by the mercury porosimeter is 0.65 mL/g or less, the boron nitride powder is excellent in a filling rate of boron nitride when preparing a composite material and is capable of exhibiting excellent heat conductive properties.

In the boron nitride powder described above, the cumulative pore volume at the fine pore radius of 0.02 to 1.2 μm that is measured by the mercury porosimeter may be 0.55 mL/g or less. In the boron nitride powder described above, since the cumulative pore volume corresponding to the fine pores having a specific fine pore radius that is measured by the mercury porosimeter is 0.55 mL/g or less, it is possible to make filling properties of boron nitride when preparing the composite material and the heat conductive properties compatible at a higher level.

In the boron nitride powder described above, an average particle diameter may be 15 to 100 μm.

One aspect of the present disclosure provides a boron carbonitride powder having an average particle diameter of 15 to 100 μm and a tap density of 1.00 to 1.50 g/mL.

Since the boron carbonitride powder described above has a specific average particle diameter and a tap density in a predetermined range, the boron carbonitride is suitable as a raw material for producing the boron nitride powder as described above. Even though it is not clear why the average particle diameter and the tap density in the predetermined range are suitable for the raw material of the boron nitride powder described above, it is considered that the boron carbonitride having an average particle diameter and a tap density in the range described above has high crystallizability and a short lattice distance, and the present inventors assume that a boron nitride powder having an internal structure denser than a boron nitride powder of the related art may be produced by using the boron carbonitride as the raw material.

One aspect of the present disclosure provides a production method for a boron nitride powder includes firing a boron carbide powder at a temperature at 2000 to 2300° C. in a nitrogen pressurized atmosphere to obtain a fired product containing boron carbonitride, and generating primary particles of boron nitride by heating a mixture containing the fired product and a boron source to obtain aggregated particles of boron nitride configured by aggregation of the primary particles described above.

In the production method for a boron nitride powder described above, the fired product containing hexagonal boron carbonitride having high crystallizability may be prepared by firing the boron carbide powder at a comparatively high temperature in the nitrogen pressurized atmosphere. After increasing the crystallizability of the boron carbonitride as described above, the boron carbonitride is mixed with a boric acid and subjected to a heating treatment, and thus, the primary particles of the boron nitride may be generated, and the aggregated particles may be formed by the aggregation of the generated primary particles. It is assumed that a lattice distance in the boron carbonitride having high crystallizability is short, and the primary particles of the hexagonal boron nitride having a dense internal structure may be formed by the short lattice distance. In the aggregated particles in which the primary particles of the hexagonal boron nitride are aggregated, internal voids of the aggregated particles may be reduced, compared to a product of the related art. Then, by using the hexagonal boron nitride of which the internal voids are reduced, a composite material to be prepared is capable of increasing filling properties of the boron nitride, and a composite material to be obtained is capable of exhibiting excellent heat conductive properties, compared to a composite material to be prepared by using a boron nitride powder of the related art.

One aspect of the present disclosure provides a composite material containing the boron nitride powder described above and a resin.

Since the composite material described above contains the boron nitride powder described above, the composite material is excellent in filling, properties and heat conductive properties.

One aspect of the present disclosure provides a heat dissipating member including the composite material described above.

Since the heat dissipating member described above includes the composite material described above, the heat dissipating member has sufficient heat dissipating properties.

### Advantageous Effects of Invention

According to the present disclosure, it is possible to provide a boron nitride powder capable of producing a composite material that is excellent in filling properties of boron nitride and is capable of exhibiting excellent heat conductive properties, and a production method for the boron nitride powder. In addition, according to the present disclosure, it is possible to provide a boron carbonitride powder useful for producing the boron nitride powder described above. In addition, according to the present disclosure, it is possible to provide a composite material that is excellent in filling properties of boron nitride and is capable of exhibiting excellent heat conductive properties. In addition, according to the present disclosure, it is possible to provide a heat dissipating member excellent in heat dissipating properties.

### BRIEF DESCRIPTION OF DRAWINGS

FIG. 1 is a graph illustrating a result of measuring a boron nitride powder obtained in Example 1 with a mercury porosimeter.

FIG. 2 is a graph illustrating a result of measuring a boron nitride powder obtained in Comparative Example 1 with a mercury porosimeter.

### DESCRIPTION OF EMBODIMENTS

Hereinafter, an embodiment of the present disclosure will be described with reference to the drawings, in some cases. Here, the following embodiment is an example for describing the present disclosure and does not limit the present disclosure to the following contents. In the description, the same reference numerals will be used in the same constituents or constituents having the same function, and the repeated description may be omitted.

Herein, only one type of materials exemplified herein can be used, or two or more types thereof can be used in combination, unless otherwise noted. In a case where there are a plurality of substances corresponding to each component in a composition, the content of each component in the composition indicates the total amount of the plurality of substances in the composition, unless otherwise noted.

One embodiment of a boron nitride powder contains aggregated particles configured by the aggregation of primary particles of boron nitride. The boron nitride powder may contain granules that are an aggregate of the aggregated particles. That is, the boron nitride powder may contain the primary particles, the aggregated particles, and the granules.

In the boron nitride powder, a cumulative pore volume at a fine pore radius of 0.02 to 1.2 μm that is measured by a mercury porosimeter is 0.65 mL/g or less. An upper limit value of the cumulative pore volume, for example, may be 0.55 mL/g or less, 0.45 mL/g or less, 0.40 mL/g or less, or 0.35 mL/g or less. A lower limit value of the cumulative pore volume is not particularly limited, and may be less than or equal to a detection limit, but in general, is 0.05 mL/g or more, or 0.1 mL/g or more since the boron nitride powder contains the aggregated particles. The cumulative pore volume may be adjusted in the range described above, and for example, may be 0.05 to 0.65 mL/g, 0.1 to 0.55 mL/g, or 0.1 to 0.45 mL/g.

In the boron nitride powder, an upper limit value of a ratio of the cumulative pore volume at the fine pore radius of 0.02 to 1.2 to the total pore volume that is measured by the mercury porosimeter, for example, may be 48% or less, 45% or less, 42% or less, 35% or less, or 33% or less. In the boron nitride powder, a lower limit value of the ratio of the cumulative pore volume at the fine pore radius of 0.02 to 1.2 μm to the total pore volume that is measured by the mercury porosimeter is not particularly limited, and for example, may be 3% or more, 5% or more, 10% or more, 20% or more, or 30% or more.

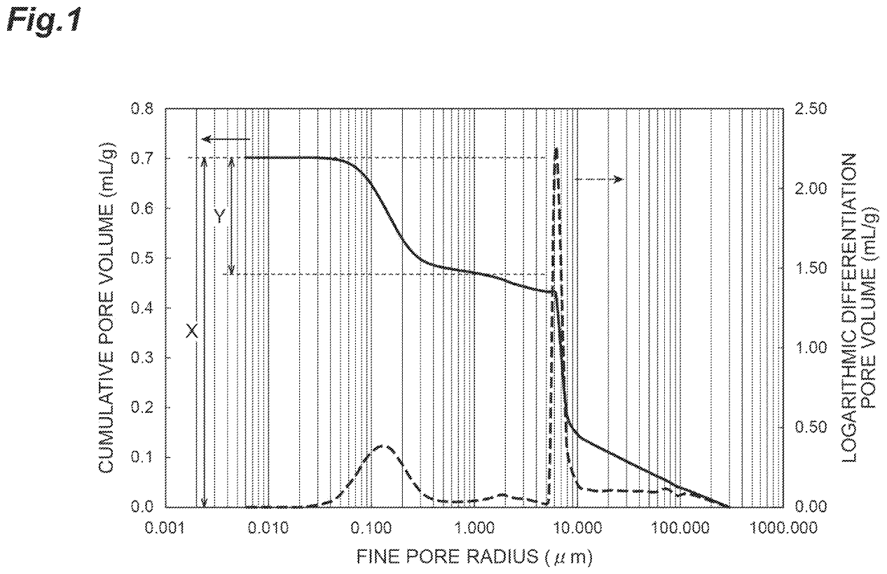

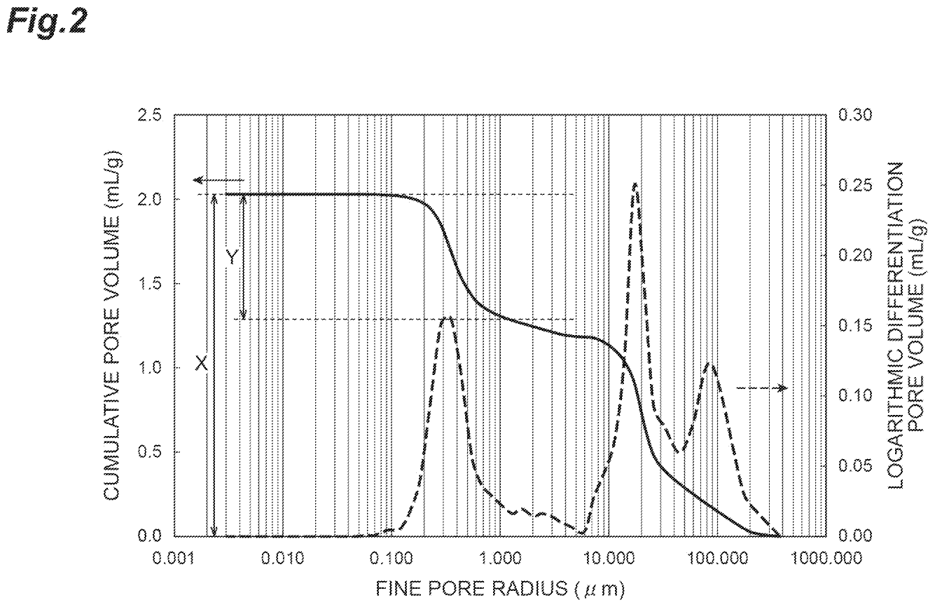

Herein, the cumulative pore volume is a value that is measured on the basis of a mercury intrusion technique based on JIS R 1655:2003 “Test methods for pore size distribution of fine ceramic green body by mercury porosimetry”. The cumulative pore volume at the fine pore radius of 0.02 to 1.2 μm can be obtained by using a result of measuring the cumulative pore volume with respect to the boron nitride powder. Specifically, the cumulative pore volume at the fine pore radius of 0.02 to 1.2 μm indicates a value obtained by subtracting a volume corresponding to pores (including pores to be formed between granules, and the like) having a fine pore radius of greater than 1.2 μm from a pore volume (hereinafter, also referred to as the total pore volume) of 0.02 μm to a measurement upper limit. The cumulative pore volume at the fine pore radius of 0.02 to 1.2 μm, for example, corresponds to a value indicated by Y, with reference to FIG. 1 and FIG. 2. In addition, the ratio of the cumulative pore volume at the fine pore radius of 0.02 to 1.2 μm indicates a value obtained by dividing the value corresponding to Y by the total pore volume. For example, since the total pore volume is a value indicated by X, the ratio of the cumulative pore volume at the fine pore radius of 0.02 to 1.2 μm is represented by Y/X, with reference to FIG. 1 and FIG. 2. Specifically, measurement and determination are performed by methods described in Examples.

In the related art, from the viewpoint of increasing a filling rate of a boron nitride powder that is used for preparing a composite material, there is an attempt to reduce a ratio of pores in the boron nitride powder (for example, Patent Literature 2). However, in the related art, the ratio of the pores (a value represented by the term of a voidage) does not necessarily correlate with heat dissipating characteristics of the boron nitride powder. According to the studies of the present inventors, even in a case of a boron nitride powder having comparable pores from the viewpoint of the voidage, when the boron nitride powder has a small ratio of pores in aggregated particles to the total pores, it is possible to produce a composite body excellent in filling properties and heat conductive properties. Then, according to the studies of the present inventors, it has been found that the cumulative pore volume in a specific range in which the fine pore radius that is measured by the mercury porosimeter is 0.02 to 1.2 μm commonly corresponds to the ratio of the pores in the aggregated particles, and a composite body excellent in the filling properties and the heat conductive properties can be produced by a boron nitride powder of which a cumulative pore volume is adjusted in a predetermined range.

In the boron nitride powder, it is preferable that a ratio of the total value of the pores in the aggregated particles (voids to be formed between the primary particles of the boron nitride) and pores to be formed between the aggregated particles to the total pore volume is small. The ratio corresponds to the voidage of the related art (for example, Patent Literature 2). Even in a plurality of boron nitride powders having the total pore volumes equal to each other, a boron nitride powder having a small ratio to the total pore volume is more excellent in the filling properties and the heat conductive properties of the composite material. The voidage, for example, may be 53 volume % or less, 50 volume % or less, 45 volume % or less, or 40 volume % or less. A lower limit value of the voidage is generally 15 volume % or more.

The voidage can be determined by using a value that is measured on the basis of a mercury intrusion technique based on JIS R 1655:2003 “Test methods for pore size distribution of fine ceramic green body by mercury porosimetry”. Specifically, the voidage indicates a value that is calculated from Expression (1) described below.

ε_{g}=V_{g}/(V_{g}+1/ρₜ)×100 (1)

In Expression (1) described above, ε_{g} is the voidage (%) of the boron nitride powder, and ρₜ is the density of 2.26 (g/cm³) of primary particles of hexagonal boron nitride. Here, V_{g} in Expression (1) described above is a value that is described as corresponding to a cumulative fine pore volume (cm³/g) of the voids in the aggregated particles, and in a case where a fine pore radius is in a range of 1.0 μm or more and set to R (μm) when the value of a logarithmic differentiation pore volume first reaches a minimum value, V_{g} is a cumulative pore volume corresponding to fine pores of a minimum fine pore radius to the fine pore radius R. In other words, V_{g} is a value obtained by dividing a value, which is obtained by subtracting a volume corresponding to pores having a fine pore radius of greater than R from the total fine pore volume, by the total pore volume.

An average particle diameter of the boron nitride powder, for example, may be 15 μm or more, 20 μm or more, 25 μm or more, 30 μm or more, or 40 μm or more, from the viewpoint of sufficiently increasing a heat conductivity. The average particle diameter, for example, may be 200 μm or less, 150 μm or less, 100 μm or less, 90 μm or less, or 80 μm or less to be preferably usable in a sheet-shaped composite material or the like. The average particle diameter may be adjusted in the range described above, and for example, may be 15 to 200 μm, 15 to 100 μm, or 15 to 80 μm.

Herein, the average particle diameter of the boron nitride powder indicates a value that is measured by using a commercially available laser diffraction scattering type particle size distribution measurement device (for example, LS-13 320, manufactured by Beckman Coulter, Inc.). The measurement is performed without the irradiation of a homogenizer, and the value of a volume average diameter (D50) is set to the average particle diameter.

The boron nitride powder, for example, can be produced by the following method. One embodiment of a production method for a boron nitride powder includes firing a boron carbide powder at a temperature of 2000 to 2300° C. in a nitrogen pressurized atmosphere to obtain a fired product (hereinafter, also referred to as a nitriding step), and generating primary particles of boron nitride by heating a mixture containing the fired product and a boron source to obtain aggregated particles configured by the aggregation of the primary particles (hereinafter, also referred to as a crystallizing step).

In the nitriding step, the boron carbide powder is fired at the temperature of 2000 to 2300° C. in the nitrogen pressurized atmosphere to obtain the fired product containing boron carbonitride (B₄CN₄) (for example, a boron carbonitride powder). In the nitriding step, a firing temperature may be 2000° C. or higher, or 2100° C. or higher. In the nitriding step, by setting a lower limit value of the firing temperature to 2000° C. or higher, it is possible to increase the crystallizability of the boron carbonitride to be obtained in the nitriding step, and to increase a ratio of hexagonal boron carbonitride. In the nitriding step, by increasing the ratio of the hexagonal boron carbonitride, it is possible to further reduce a ratio of a cumulative pore volume at a fine pore radius of 0.02 to 1.2 μm to the total cumulative pore volume that is measured by a mercury porosimeter. In addition, the firing temperature may be 2300° C. or lower, or 2250° C. or lower. The firing temperature may be adjusted in the range described above, and for example, may be 2000 to 2300° C.

Here, whether or not the ratio of the hexagonal boron carbonitride is increased can be checked by a tap density of the fired product. In the present disclosure, the temperature of the nitriding step is selected from a range higher than usual, and the tap density of the fired product may be set to be in a specific range (a specific numerical range will be described below). A threshold value of a heating temperature at which a desired tap density is obtained is changed in accordance with the type of raw material component, a composition, and the like, but tends to be in the temperature range described above. Note that, several production examples are obtained in advance by using compositions having different raw material components and different compositions, and from results to be obtained, a suitable firing temperature can be determined. For example, in a case where the obtained tap density of the boron carbonitride is less than the desired tap density, boron carbonitride having a desired tap density can be obtained by increasing the firing temperature. Similarly, a suitable firing temperature can be easily determined with respect to various compositions.

In the nitriding step, a pressure may be 0.6 MPa or more, 0.7 MPa or more, or 0.8 MPa or more. In the nitriding step, by setting a lower limit value of the pressure to 0.6 MPa or more, it is possible to suppress a decrease in reactivity due to the volatilization of a boric acid to the outside of a system, and to allow the nitriding of the boron carbide to sufficiently proceed. In the nitriding step, the pressure may be 1.0 MPa or less, or 0.9 MPa or less. In the nitriding step, by setting an upper limit value of the pressure to 1.0 MPa or less, it is possible to suppress an increase in the production cost. The pressure may be adjusted in the range described above, and for example, may be 0.6 to 1.0 MPa.

In the nitriding step, a nitrogen gas concentration of the nitrogen pressurized atmosphere, for example, may be 95 volume % or more, 98 volume % or more, or 99.9 volume % or more. In the nitriding step, a firing time is not particularly limited within a range where the nitriding is sufficiently performed, for example, may be 6 to 30 hours, or 8 to 20 hours.

In the fired product containing the boron carbonitride (B₄CN₄) that is obtained in the nitriding step, the tap density tends to be greater than a tap density of a fired product that is obtained by a method of the related art. A lower limit value of the tap density of the fired product, for example, may be 1.00/mL or more, 1.05 g/mL or more, or 1.10 g/mL or more, from the viewpoint of reducing the final cumulative pore volume of the boron nitride, and an upper limit value of the tap density of the fired product, for example, may be 1.50 g/mL or less, or 1.40 g/mL or less since a real density is 2.3.

Herein, the tap density indicates a value that is obtained on the basis of JIS R 1628:1997 “Test methods for bulk density of fine ceramic powder”. In the measurement, a commercially available device can be used. Specifically, a value obtained by filling a dedicated container of 100 cm³ with a measurement target such as the fired product, and by measuring a bulk density after performing tapping in a condition where a tapping time is 180 seconds, the number of times for tapping is 180 times, and a tap lift is 18 mm is set to the tap density.

A lower limit value of an average particle diameter of the fired product containing the boron carbonitride (B₄CN₄), for example, may be 15 μm or more, 20 μm or more, or 25 μm or more. An upper limit value of the average particle diameter of the fired product containing the boron carbonitride, for example, may be 100 μm or less, 90 μm or less, or 80 μm or less. The average particle diameter of the fired product containing the boron carbonitride may be adjusted in the range described above, and for example, may be 15 to 100 μm. The boron carbonitride may have an average particle diameter of 15 to 100 μm or less and a tap density of 1.00 to 1.50 g/mL.

In the crystallizing step, the primary particles of the boron nitride are generated by heating a compounded product containing the fired product containing the boron carbonitride that is obtained in the nitriding step, and the boron source, and the boron nitride powder containing the aggregated particles configured by the aggregation of the primary particles is obtained. That is, in the crystallizing step, the boron carbonitride is decarbonized, and primary particles having a predetermined size are generated and aggregated to obtain the boron nitride powder containing the aggregated particles. In this case, the boron nitride powder may contain granules that are an aggregate of the aggregated particles.

Examples of the boron source include a boric acid, boron oxide, or a mixture thereof. In the crystallizing step, the mixture that is heated may contain known additives.

In the mixture, a compounding ratio of the boron carbonitride and the boron source can be suitably set in accordance with a molar ratio. In a case where at least one of a boric acid and boron oxide is used as the boron source, for example, the boron source may be compounded such that the total amount of the boric acid and the boron oxide is 100 to 300 parts by mass, or the boron source may be compounded such that the total amount of the boric acid and the boron oxide is 150 to 250 parts by mass, with respect to 100 parts by mass of the boron carbonitride.

In the crystallizing step, a heating temperature for heating the mixture, for example, may be 2000° C. or higher, or 2100° C. or higher. By setting a lower limit value of the heating temperature to 2000° C. or higher, it is possible to allow a grain growth to sufficiently proceed. In the crystallizing step, the heating temperature for heating the mixture, for example, may be 2150° C. or lower, or 2100° C. or lower. By setting an upper limit value of the heating temperature to 2150° C. or lower, it is possible to suppress the yellowing of the BN powder. The heating temperature may be adjusted in the range described above, and for example, may be 2000 to 2150° C. It is preferable that the heating temperature for heating the mixture in the crystallizing step is lower than the heating temperature of the boron carbide powder in the nitriding step.

In the crystallizing step, the heating may be performed in an ordinary pressure (Atmospheric Pressure: 50 kPa or less) atmosphere, or the heating may be performed at a pressure of greater than the atmospheric pressure by pressurizing. In a case of pressurizing, for example, the pressure may be 0.5 MPa or less, or 0.3 MPa or less.

In the crystallizing step, a heating time may be 0.5 hours or longer, 1 hour or longer, or 3 hours or longer. By setting a lower limit value of the heating time to 0.5 hours or longer, it is possible to allow the grain growth to sufficiently proceed. In the crystallizing step, the heating time may be 40 hours or shorter, 30 hours or shorter, 20 hours or shorter, or 10 hours or shorter. By setting an upper limit value of the heating time to 40 hours or shorter, it is possible to suppress an increase in the production cost. The heating time may be adjusted in the range described above, and for example, may be 0.5 to 40 hours, or 1 to 30 hours.

The production method for a boron nitride powder may include other steps. Examples of the other steps include a pulverizing step, a classifying step, and the like. In the production method for a boron nitride powder, for example, the pulverizing step may be performed after the crystallizing step. In the pulverizing step, a general pulverizer or a general crusher can be used. For example, a ball mill, a vibration mill, a jet mill, and the like can be used. Note that, herein, “pulverizing” also includes “crushing”. The average particle diameter of the boron nitride powder may be adjusted to 15 to 200 μm by pulverizing and classifying.

The boron nitride powder is useful when preparing a composite material with a resin. That is, one embodiment of the composite material contains the boron nitride powder described above and a resin. The composite material may be a resin composition that is capable of exhibiting heat conductive properties, or may be a sheet-shaped product such as a heat dissipating sheet.

Examples of the resin include an epoxy resin, a silicone resin, silicone rubber, an acrylic resin, a phenolic resin, a melamine resin, a urea resin, unsaturated polyester, a fluorine resin, polyamide, polyimide, polyamide imide, polyether imide, polyester (for example, polybutylene terephthalate, polyethylene terephthalate, and the like), polyphenylene ether, polyphenylene sulfide, wholly aromatic polyester, polysulfone, a liquid crystal polymer, polyether sulfone, polycarbonate, a maleimide-modified resin, an ABS resin, an acrylonitrile-acrylic rubberstyrene (AAS) resin, an acrylonitrileethylenepropylenediene rubber-styrene (AES) resin, and the like. The resin may be a mixture of such resin raw materials and a curing agent.

In the resins described above, an epoxy resin (for example, a naphthalene type epoxy resin) has excellent heat resistance and excellent adhesion strength to a copper foil circuit, and thus, is preferable as an insulating layer of a printed-wiring board. In addition, a silicone resin has excellent heat resistance, excellent flexibility, and excellent adhesiveness to a heatsink or the like, and thus, is preferable as a thermal interface material.

The composite material may be obtained by compounding the boron nitride powder, the resin described above or a monomer to be a raw material thereof, and as necessary, a curing agent at a predetermined ratio, and by curing a resin raw material with heat or light. Specifically, examples of the curing agent in a case of using an epoxy resin include a phenol novolac resin, an acid anhydride resin, an amino resin, and imidazoles. Among them, imidazoles are preferable. A compounding amount of the curing agent, for example, may be 0.5 to 15 parts by mass, or 1.0 to 10 parts by mass, with respect to 100 parts by mass of the raw material (monomer).

The content of the boron nitride powder in the composite material, for example, may be 30 to 85 volume %, or 40 to 80 volume % or less, on the basis of the total composite material. By setting the content to 30 volume % or more, it is possible to obtain a composite material having sufficiently high heat conductive properties and sufficient heat dissipating performance. By setting the content to 85 volume % or less, it is possible to reduce voids that are generated in molding, and to further increase insulating properties and a mechanical strength. Note that, the composite material may contain components other than the boron nitride powder and the resin. In this case, the total content of the boron nitride powder and the resin in the composite material, for example, may be 80 mass % or more, 90 mass % or more, or 95 mass % or more.

The composite material is excellent in the heat conductive properties, and thus, for example, can be preferably used as a heat dissipating member such as a heat dissipating sheet and a metal base substrate.

Some embodiments have been described above, and the description of the common configurations can be applied to each other. In addition, the present disclosure is not limited to the embodiments described above.

### EXAMPLES

The contents of the present disclosure will be described in more detail with reference to Examples and Comparative Examples, but the present disclosure is not limited to the following Examples.

### Example 1

[Preparation of Hexagonal Boron Carbonitride]

100 parts by mass of an orthoboric acid, manufactured by Nippon Denko Co., Ltd., and 35 parts by mass of acetylene black (Product Name: HS100), manufactured by Denka Company Limited, were mixed with a Henschel mixer. The obtained mixture was filled in a graphite crucible and heated in an arc furnace at 2200° C. for 5 hours in an argon atmosphere to obtain lumpy boron carbide (B₄C). The obtained lumpy product was subjected to coarse pulverization with a jaw crusher to obtain a coarse powder. Such a coarse powder was further pulverized with a ball mill including a silicon carbide ball (ϕ10 mm) to obtain a pulverized powder. The pulverization using the ball mill was performed at the number of rotations of 20 rpm for 60 minutes. After that, the pulverized powder was classified by using a vibration sieve having a mesh size of 45 μm. A fine powder on the sieve was subjected to airflow classification with a CLASSIEL classifier to obtain a boron carbide powder having a particle diameter of 10 μm or more. A carbon amount of the obtained boron carbide powder was 19.9 mass %. The carbon amount was measured with a carbon/sulfur simultaneous analyzer.

The prepared boron carbide powder was heated by using a resistance heating furnace in a nitrogen gas atmosphere for 12 hours in a condition where a firing temperature was 2150° C. and a pressure was 0.90 MPa. In the firing, nitrogen gas was supplied such that a nitrogen gas amount was greater than a stoichiometric amount and is 20 equivalents greater than a requisite amount. As described above, a fired product containing boron carbonitride (B₄CN₄) was obtained. A tap density of the fired product was 1.17 g/mL. In addition, as a result of analysis with XRD, the generation of hexagonal boron carbonitride was checked. After that, subsequently, the fired product was filled in an alumina crucible, and then, heated by using a muffle furnace in an air atmosphere for 5 hours in a condition where a firing temperature was 700° C.

[Preparation of Boron Nitride Powder]

The fired product and a boric acid were compounded at a ratio at which the boric acid was 100 parts by mass with respect to 100 parts by mass of boron carbonitride, and mixed by using a Henschel mixer. The obtained mixture was filled in a boron nitride crucible and heated by using a resistance heating furnace to 1000° C. from a room temperature at a temperature increase rate of 10° C./minute in a nitrogen gas atmosphere in an atmospheric pressure condition. Subsequently, heating was performed to 2000° C. from 1000° C. at a temperature increase rate of 2° C./minute. The heating was performed by retaining at 2000° C. for 5 hours to obtain boron nitride containing aggregated particles configured by the aggregation of primary particles. The obtained boron nitride was crushed with a Henschel mixer for 20 minutes, and then, sieved with a vibration sieve having a mesh size of 95 μM to obtain a boron nitride powder.

<Evaluation of Boron Nitride Powder>

A cumulative pore volume and a logarithmic differentiation pore volume of the boron nitride powder obtained as described above were measured by using a mercury porosimeter in accordance with the following procedure. As a device, AutoPore IV9500 manufactured by Shimadzu Corporation was used, and as a measurement cell, 5 cc×1.1 cc for a powder was used. The measurement was performed by setting the highest pressure of the device to 228 MPa and a measurement range of a fine pore diameter to 500 μm or less and 0.0055 μm or more. Results are shown in Table 1 and FIG. 1. FIG. 1 is a graph illustrating a result of measuring the boron nitride powder obtained in Example 1 with a mercury porosimeter.

More specifically, approximately 0.7 g of the boron nitride powder was filled in a powder cell such that a stem usage rate was 50 to 80%, and a metal cap was attached. In this case, grease (Product Name: APIEZON, manufactured by Leef Energy K.K.) was applied around a contact surface with the metal cap on the cell side with approximately half the width from the outside. A resin nut was further attached and fastened by using a jig such that there was no looseness. Next, high vacuum grease was applied to a position of 1 to 5 cm from a stem portion of the cell and homogeneously spread. After that, the cell was set in a low-pressure part pressure chamber (low-pressure port), and measurement was started. After the measurement on the low pressure side was ended, the cell was taken out, and weight was measured in a state where the grease was not wiped out. The cell was set in a high-pressure part pressure chamber, the chamber was slowly closed, and the opening and closing of a lid were repeated. When high-pressure fluid containing air bubbles did not come out to a vent valve, the lid was fastened, and the measurement of the high pressure part was started. Note that, the measurement was performed such that the total number of measurement points was 42 at a pressure in the measurement range described above.

<Evaluation as Boron Nitride Powder for Composite Material>

A composite material was prepared by using the boron nitride powder described above and a resin, and filling properties and heat conductive properties of the boron nitride powder were evaluated. Results are shown in Table 1.

[Evaluation of Filling Properties of Boron Nitride]

The characteristics of the boron nitride powder obtained as described above as a filling material with respect to the resin were evaluated. First, 100 parts by mass of a naphthalene type epoxy resin (Product Name: HP4032, manufactured by DIC Corporation), and 10 parts by mass of imidazoles (Product Name: 2E4MZ-CN, manufactured by Shikoku Chemicals Corporation) as a curing agent were mixed to obtain a mixture. Mixing was performed at a ratio of 65 parts by volume of the boron nitride powder to 100 parts by volume of the mixture to obtain a coating agent. The coating agent was applied onto a sheet-shaped PET base material having Width: 110 mm such that a thickness was 1.0 mm, and then, reduced-pressure defoaming was performed at 500 Pa for 10 minutes. After that, uniaxial press was performed for 60 minutes in a condition where a pressure was 160 kg/cm² while performing heating at 150° C. to obtain a heat dissipating sheet (composite material) having a thickness of 0.5 mm. The heat dissipating sheet prepared as described above was subjected to visual observation, and the filling properties of the boron nitride powder with respect to the resin were evaluated on the basis of the following criteria.

A: It was possible to homogeneously form a film without having unevenness, holes, cracks, and the like on a sheet.

B: Some unevenness and cracks were checked on the entire sheet, but it was possible to form a homogeneous film in a range of at least 50 mm square.

C: Unevenness, holes, cracks, or the like were checked on a sheet, and it was not possible to homogeneously form a film, or shape retention properties of the sheet were degraded, and it was not possible to form a film of 50 mm square or more.

[Evaluation of Heat Dissipating Properties as Heat Dissipating Sheet]

The performance of the heat dissipating sheet obtained as described above was evaluated. As a heat conductivity of the obtained heat dissipating sheet in a uniaxial press direction, a heat conductivity (H: unit of W/(m·K)) was calculated by a calculation expression of H=T×D×C using a thermal diffusivity coefficient (T: unit of m²/second), a density (D: unit of kg/m³), and a specific heat capacity (C: unit of J/(kg·K). The thermal diffusivity coefficient T was measured with a sample obtained by processing the heat dissipating sheet to have a size of Length×Breadth×Thickness=10 mm×10 mm×0.3 mm by a laser flash method. As a measurement device, a xenon flash analyzer (Product Name: LFA447NanoFlash, manufactured by NETZSCH-Geratebau GmbH) was used. The density D was measured by an Archimedes method. The specific heat capacity C was measured by using a differential scanning calorimeter (Device Name: ThermoPlusEvo DSC8230, manufactured by Rigaku Corporation). Measurement results shown in Table 1 were described as a relative value in which the value of a heat conductivity of Comparative Example 2 was set to 1.0.

### Example 2

A boron nitride powder was obtained as with Example 1, except that the firing temperature was changed to 2050° C. As with Example 1, a cumulative pore volume and a logarithmic differentiation pore volume of the obtained boron nitride powder were measured, and filling properties and heat dissipating properties of the obtained boron nitride powder were evaluated. Results are shown in Table 1.

### Example 3

A boron nitride powder was obtained as with Example 1, except that the pulverizing time of the boron carbonitride was changed to 0.5 hours, and a pulverized product having an average particle diameter of 40 μm was prepared. Note that, the boron nitride powder was obtained by being sieved with a vibration sieve having a mesh size of 150 μm. As with Example 1, a cumulative pore volume and a logarithmic differentiation pore volume of the obtained boron nitride powder were measured, and filling properties and heat dissipating properties of the obtained boron nitride powder were evaluated. Results are shown in Table 1.

### Comparative Example 1

15.9 mass % of an amorphous boron nitride powder having an oxygen content of 2.3%, a purity of 96.5%, and a calcium content of 70 ppm, 5.5 mass % of hexagonal boron nitride having an oxygen content of 0.1%, a purity of 98.9%, and a calcium content of 30 ppm, 0.55 mass % of calcium carbonate (PC-700, manufactured by Shiraishi Kogyo Kaisha, Ltd.), and 78.1 mass % of water were measured in a container, mixed by using a Henschel mixer, and then, pulverized by using a ball mill for 4 hours to obtain water slurry. Further, 0.5 parts by mass of a polyvinyl alcohol resin (manufactured by The Nippon Synthetic Chemical Industry Co., Ltd.) was added to 100 parts by mass of the water slurry, heated and stirred at 50° C. until being dissolved, and then, subjected to a spheroidizing treatment by a spray drier at a dry temperature of 230° C. Note that, as a spheroidizing device of the spray drier, a rotary atomizer was used, and the treatment was performed at 7300 rotations.

The obtained treated product was fired in a batch-type high-frequency furnace at a firing temperature of 1850° C. for 5 hours, and then, a fired product was crushed and subjected to a classifying treatment with a sieve of 250 μm to obtain a boron nitride powder. As with Example 1, a cumulative pore volume and a logarithmic differentiation pore volume of the obtained boron nitride powder were measured. Results are shown in Table 1 and FIG. 2. FIG. 2 is a graph illustrating a result of measuring the boron nitride powder obtained in Comparative Example 1 with a mercury porosimeter. In addition, as with Example 1, filling properties and heat dissipating properties of the obtained boron nitride powder were evaluated. Results are shown in Table 1. Note that, in Table 1, “-” indicates a case where the measurement was not available.

### Comparative Example 2

A boron nitride powder was obtained as with Comparative Example 1, except that the raw material composition was changed to 33.3 mass % of the amorphous boron nitride powder, 10.5 mass % of the hexagonal boron nitride, 1.15 mass % of the calcium carbonate, and 54.0 mass % of the water. As with Example 1, a cumulative pore volume and a logarithmic differentiation pore volume of the obtained boron nitride powder were measured, and filling properties and heat dissipating properties of the obtained boron nitride powder were evaluated. Results are shown in Table 1.

### Comparative Example 3

A boron nitride powder was obtained as with Example 1, except that boron carbide (B₄C) was filled in a boron nitride crucible and heated by using a resistance heating furnace in a nitrogen gas atmosphere for 12 hours in a condition where a firing temperature was 1980° C. and a pressure was 0.85 MPa, and in the heating, nitrogen gas was supplied such that a supply amount of the nitrogen gas was 5 equivalents. As with Example 1, a cumulative pore volume and a logarithmic differentiation pore volume of the obtained boron nitride powder were measured, and filling properties and heat dissipating properties of the obtained boron nitride powder were evaluated. Results are shown in Table 1.

TABLE 1

| | Boron carbonitride | | Boron nitride powder | | | | | |
|---|---|---|---|---|---|---|---|---|
| | powder | | Cumulative pore | Ratio of cumulative | | Average | | |
| | Average | | volume at fine pore | pore volume at fine | | particle | Evaluation | |
| | particle | Tap | radius of 0.02 to | pore radius of 0.02 to | | diameter | | Heat |
| | diameter D50 | density | 1.2 μm | 1.2 μm | Voidage | D50 | Filling | conductive |
| | [μm] | [g/mL] | [mL/g] | [%] | [volume %] | [μm] | properties | properties |
| Example 1 | 35 | 1.17 | 0.23 | 35 | 38 | 40 | A | 1.5 |
| Example 2 | 35 | 1.08 | 0.32 | 42 | 53 | 40 | A | 1.4 |
| Example 3 | 70 | 1.21 | 0.22 | 33 | 37 | 80 | A | 1.6 |
| Comparative | — | — | 0.73 | 62 | 66 | 65 | C | —* |
| Example 1 | | | | | | | | |
| Comparative | — | — | 0.67 | 50 | 53 | 65 | C | 1.0 |
| Example 2 | | | | | | | | |
| Comparative | 35 | 0.90 | 0.66 | 49 | 58 | 40 | B | 1.2 |
| Example 3 | | | | | | | | |

As shown in Table 1, it was checked that a boron nitride powder of which a cumulative pore volume at a fine pore radius of 0.02 to 1.2 μm was 0.65 mL/g or less was excellent in the filling properties and the heat dissipating properties. In particular, from the results of Example 2 and Comparative Example 2 showing the same value of 53 in a voidage that is an evaluation index of the related art, it was checked that even in a case of having the same voidage, a boron nitride powder having a small cumulative pore volume at a fine pore radius of 0.02 to 1.2 μm was excellent in the filling properties and the heat dissipating properties.

### INDUSTRIAL APPLICABILITY

According to the present disclosure, it is possible to provide a boron nitride powder capable of producing a composite material that is excellent in filling properties of boron nitride and is capable of exhibiting excellent heat conductive properties, and a production method for the boron nitride powder. In addition, according to the present disclosure, it is possible to provide a composite material that is excellent in filling properties of boron nitride and is capable of exhibiting excellent heat conductive properties. In addition, according to the present disclosure, it is possible to provide a heat dissipating member excellent in heat dissipating properties.

1. A boron nitride powder, comprising:
aggregated particles configured by aggregation of primary particles of boron nitride,
wherein a cumulative pore volume at a fine pore radius of 0.02 to 1.2 μm that is measured by a mercury porosimeter is 0.65 mL/g or less.

2. The boron nitride powder according to claim 1,
wherein the cumulative pore volume at the fine pore radius of 0.02 to 1.2 μm that is measured by the mercury porosimeter is 0.55 mL/g or less.

3. The boron nitride powder according to claim 1,
wherein an average particle diameter is 15 to 100 μm.

4. A boron carbonitride powder having an average particle diameter of 15 to 100 μm and a tap density of 1.00 to 1.50 g/mL.

5. A production method for a boron nitride powder, comprising:
firing a boron carbide powder at a temperature of 2000 to 2300° C. in a nitrogen pressurized atmosphere to obtain a fired product containing boron carbonitride; and
generating primary particles of boron nitride by heating a mixture containing the fired product and a boron source to obtain aggregated particles configured by aggregation of the primary particles.

6. A composite material, comprising:
the boron nitride powder according to claim 1; and
a resin.

7. A heat dissipating member, comprising:
the composite material according to claim 6.
